(19) United States
(12) Patent Application Publication
(10) Pub. No.: US 2021/0334551 A1
(43) Pub. Date: Oct. 28, 2021

(54) ENVIRONMENT RECOGNITION SYSTEM AND LEARNING APPARATUS

(71) Applicant: OMRON Corporation, Kyoto-shi, KYOTO (JP)

(72) Inventor: Tanichi ANDO, Komaki-shi (JP)

(73) Assignee: OMRON Corporation, Kyoto-shi, KYOTO (JP)

(21) Appl. No.: 16/479,619

(22) PCT Filed: Jan. 18, 2018
(86) PCT No.: PCT/JP2018/001305

§ 371 Date: Jul. 22, 2019

(30) Foreign Application Priority Data
Feb. 22, 2017 (JP) 2017-031089

(51) Int. Cl. G06K 9/00; G06T 7/00; G06K 9/46; G06K 9/62

(52) U.S. Cl. CPC G06K 9/00791; G06T 7/0002; G06T 2207/30252; G06K 9/6257; G06T 2207/10148; G06K 9/46

(57) ABSTRACT

An environment recognition system according to one aspect of the present invention includes: a sensor apparatus configured to detect brightness information pertaining to a brightness of the surrounding environment; and an information processing apparatus configured to calculate, by inputting the brightness information obtained by the sensor apparatus into a trained learning device that has been trained for identifying a brightness level of the surrounding environment and a factor determining the brightness, an environment information set including information of the brightness level of the surrounding environment and the factor determining the brightness.

### TECHNICAL FIELD

The present invention relates to an environment recognition system and a learning apparatus.

### BACKGROUND ART

JP H05-169963A proposes a vehicle air conditioning control apparatus that controls the air flow of a vehicle air conditioner on the basis of a sunlight amount detected by sunlight amount detection means. JP 2015-051687A proposes a vehicle light control apparatus that controls the lighting and extinguishing of vehicle headlights on the basis of an infrared light level detected by an infrared light sensor and a visible light level detected by a visible light sensor.

### CITATION LIST

### Patent Literature

### [PTL 1] JP H05-169963A

### [PTL 2] JP 2015-051687A

### SUMMARY OF INVENTION

### Technical Problem

As exemplified in JP H05-169963A and JP 2015-051687A, information indicating the brightness of the surrounding environment has been used by various apparatuses in the past. However, the inventor of the present invention found the following problem with such apparatuses. Past apparatuses basically use only information indicating brightness levels that can be detected by various types of sensors. Thus the inventor of the present invention found that only simple conditions in the surrounding environment can be recognized, whereas complex conditions cannot be handled.

Consider, for example, a case in which vehicle headlights are controlled on the basis of information indicating a brightness level detected by a sensor. Assume that in this case, an area where light is blocked by a structure such as an overpass or a building and an area where the vehicle has entered a structure such as a tunnel have the same brightness level. With the simple method, it is difficult to control the headlights to not light in the former areas but to light in the latter areas.

Having been achieved in light of such circumstances, an object of one aspect of the present invention is to provide a technique that makes it possible to respond to complex conditions in the surrounding environment.

### Solution to Problem

The present invention employs the following configuration to solve the above-described problems.

An environment recognition system according to one aspect of the present invention includes: a sensor apparatus configured to detect brightness information pertaining to a brightness of the surrounding environment; and an information processing apparatus configured to obtain, by inputting the brightness information obtained by the sensor apparatus into a trained learning device that has been trained for identifying a brightness level of the surrounding environment and a factor determining the brightness, an environment information set including information of the brightness level of the surrounding environment and the factor determining the brightness.

According to the configuration described above, both the brightness level and determination factors that determine that brightness can be specified by using the trained learning device that has been trained to identify the brightness level in the surrounding environment and factors determining the brightness. As such, even when the brightness is approximately the same level, the conditions of that situation can be identified, which makes it possible to handle complex conditions in the surrounding environment. “Brightness information” may be any information expressing brightness, such as images or brightness measurement values. “Environment information set” refers to a state in which a plurality of pieces of environment information are present, and includes at least one piece of information indicating a brightness level and one piece of information indicating a factor determining the brightness. “Environment information”, meanwhile, refers to information indicating the brightness level of the surrounding environment or determination factors that determine that brightness.

In the environment recognition system according to the above-described aspect, the environment information set may include a plurality of pieces of environment information of different types; and the learning device may include a plurality of output units, each output unit provided for one of the pieces of environment information, and each output unit outputting a corresponding one of the pieces of environment information. According to this configuration, a plurality of pieces of environment information of different types can be outputted.

In the environment recognition system according to the above-described aspect, the information processing apparatus may include an output selection unit configured to selectively output a plurality of pieces of the environment information included in the environment information set to a module that uses the environment information; and the output selection unit may select environment information to use from among the environment information outputted from the output units, and outputs the selected environment information to the module. According to this configuration, the module can be controlled by the outputted environment information. The module need not be particularly limited as long as it is a device that can use environment information, and includes units of hardware or software that change some kind of physical state, or combinations of such hardware or software units, such as air conditioning devices, vehicle headlights, display backlights, and so on. The module includes a general control device that carries out general control of individual units of hardware or software or a plurality of combinations thereof, such as an Engine Control Unit (ECU) provided in a vehicle. Note that the output selection unit can output the environment information to the module directly or indirectly. In other words, the output from the output selection unit may be outputted directly to the module by having the information processing apparatus and the module connected to each other directly, or the output from the output selection unit may be outputted indirectly to the module by having the information processing apparatus and the module connected via a predetermined relay device.

In the environment recognition system according to the above-described aspect, the output selection unit may select the environment information to use from among the environment information outputted from the output units on the basis of details of the environment information outputted from the output units, and output the selected environment information to the module. According to this configuration, complex control of the module is possible by setting an output destination of the environment information on the basis of the details of the environment information.

In the environment recognition system according to the above-described aspect, the plurality of output units may be associated with a plurality of modules that use the environment information, and each output unit may output a piece of the environment information to the module corresponding to that output unit. According to this configuration, the module can be controlled by the outputted environment information.

In the environment recognition system according to the above-described aspect, the sensor apparatus may be configured to detect the brightness information from each of three or more different directions. According to this configuration, the accuracy of analyzing the surrounding environment can be improved by detecting the brightness information from three or more different directions.

In the environment recognition system according to the above-described aspect, the sensor apparatus may be constituted by an optical sensor, the optical sensor including an optical member having a plurality of focusing units that each focuses light from the surrounding environment, and a plurality of image capturing devices, each image capturing device provided corresponding to one of the focusing units and configured to receive the light focused by the focusing unit and form a captured image in which the surrounding environment appears as the brightness information. According to this configuration, the accuracy of analyzing the surrounding environment can be improved by obtaining a plurality of captured images as the brightness information.

In the environment recognition system according to the above-described aspect, at least one focusing unit among the plurality of focusing units may have different optical properties from the other focusing units. According to this configuration, the accuracy of analyzing the surrounding environment can be improved by obtaining a plurality of captured images, which reflect diverse optical properties, as the brightness information. Note that “optical properties” refers to the optical properties of the focusing units, and refers to any properties that alter the state of light between before and after the focusing unit, such as the focus angle, refractive index, band of light allowed to pass (optical density), turbidity, which is a measure of transparency, transmittance, whiteness, which indicates a white level, and tone, indicating coloration.

In the environment recognition system according to the above-described aspect, at least some of the plurality of focusing units may have irregular optical properties. According to this configuration, the accuracy of analyzing the surrounding environment can be improved by obtaining a plurality of captured images, which reflect diverse optical properties, as the brightness information. Note that at least some of the plurality of focusing units having “irregular optical properties” refers to a state in which the optical properties differ between adjacent ones of the focusing units. However, the range of irregularity need not be limited to part of the optical member, and may instead be the entire optical member.

In the environment recognition system according to the above-described aspect, the optical member may include at least one of a lens array, a diffraction grating, a diffusion lens, and a hologram lens. According to this configuration, an optical sensor capable of obtaining a plurality of captured images, which reflect diverse optical properties, as the brightness information can be manufactured with ease.

In the environment recognition system according to the above-described aspect, the sensor apparatus may be constituted by one or more illuminance sensors. According to this configuration, a sensor apparatus capable of obtaining the brightness information can be manufactured with ease.

In the environment recognition system according to the above-described aspect, the learning device may be constituted by a neural network, a support vector machine, a self-organizing map, or a learning device that learns through reinforcement learning. According to this configuration, a learning device that outputs the brightness level of the surrounding environment and factors determining the brightness can be constructed with ease.

In the environment recognition system according to the above-described aspect, the brightness level may be expressed as a continuous amount using a predetermined physical unit, and/or as a brightness level that represents the brightness in stages. According to this configuration, an environment recognition system that outputs a continuous amount using a predetermined physical unit, and/or a brightness level that represents the brightness in stages, as the environment information indicating the brightness level, can be provided.

In the environment recognition system according to the above-described aspect, the predetermined physical unit may be expressed as at least one of illuminance, sunlight amount, light beams, light intensity, luminescence, light energy, and visibility. According to this configuration, an environment recognition system that outputs a continuous amount expressed by at least one of illuminance, sunlight amount, light beams, light intensity, luminescence, light energy, and visibility as the environment information indicating the brightness level can be provided.

In the environment recognition system according to the above-described aspect, the factor determining the brightness may be expressed by at least one of the presence/absence of a light-shielding object that blocks light, a type of the light-shielding object, whether or not the sun is out, the weather, the time, and a level of urbanization. According to this configuration, an environment recognition system that outputs, as the environment information indicating factors determining the brightness, at least one of the presence/absence of light-shielding objects that block light, the type of such light-shielding objects, whether or not the sun is out, the weather, the time, and level of urbanization, can be provided. “Level of urbanization” refers to the degree of urban development, and is information used to identify whether an area is a metropolitan area, a large city, a medium-to-small city, a rural village, a suburb, an isolated location, or the like, for example.

A learning apparatus according to one aspect of the present invention includes: an information obtainment unit configured to obtain brightness information pertaining to a brightness of a surrounding environment from a sensor apparatus configured to detect the brightness information; and a learning processing unit configured to train a learning device to output an environment information set including information of a brightness level of the surrounding environment and a factor determining the brightness upon the obtained brightness information being inputted. According to this configuration, a learning apparatus that constructs a trained learning device trained to identify the brightness level of the surrounding environment and factors determining the brightness can be provided.

### Advantageous Effects of Invention

According to the present invention, a technique that makes it possible to respond to complex conditions in the surrounding environment can be provided.

### BRIEF DESCRIPTION OF DRAWINGS

FIG. 1 schematically illustrates an example of a situation in which an environment recognition system and a learning apparatus according to an embodiment are applied.

FIG. 2 schematically illustrates an example of the hardware configuration of a vehicle-mounted apparatus according to the embodiment.

FIG. 3A schematically illustrates an example of the configuration of an optical sensor according to the embodiment.

FIG. 3B schematically illustrates an example of the configuration of the optical sensor according to the embodiment.

FIG. 4 schematically illustrates an example of the hardware configuration of the learning apparatus according to the embodiment.

FIG. 5 schematically illustrates an example of the functional configuration of the vehicle-mounted apparatus according to the embodiment.

FIG. 6 schematically illustrates an example of the functional configuration of the learning apparatus according to the embodiment.

FIG. 7 illustrates an example of a processing sequence carried out by the vehicle-mounted apparatus according to the embodiment.

FIG. 8 illustrates an example of a processing sequence carried out by the learning apparatus according to the embodiment.

FIG. 9 schematically illustrates an example of the configuration of a vehicle-mounted apparatus according to a variation.

FIG. 10 schematically illustrates an example of the configuration of a vehicle-mounted apparatus according to a variation.

### DESCRIPTION OF EMBODIMENTS

An embodiment according to an aspect of the present invention (also called “the present embodiment” below) will be described next with reference to the drawings. However, the present embodiment described below is in all senses merely examples of the present invention. It goes without saying that many improvements and changes can be made without departing from the scope of the present invention. In other words, specific configurations based on the embodiment can be employed as appropriate in carrying out the present invention. For example, the following describes an example in which the present invention is applied in a vehicle-mounted system installed in a vehicle as the present embodiment. However, the subject to which the present invention is applied is not intended to be limited to vehicle-mounted systems, and may be selected as appropriate in accordance with the embodiment. Note that although the data mentioned in the present embodiment is described with natural language, the data is more specifically defined by quasi-language, commands, parameters, machine language, and so on that can be recognized by computers.

### § 1 Application Example

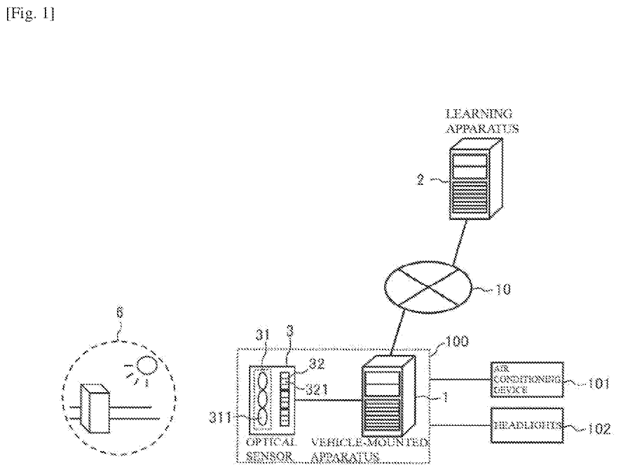

First, an example of a situation in which the present invention is applied will be described using FIG. 1. FIG. 1 schematically illustrates an example of a situation in which an environment recognition system 100 and a learning apparatus 2 according to the present embodiment are applied. The environment recognition system 100 according to the present embodiment is an information processing system, installed in a vehicle such as an automobile, that analyzes a brightness level of a surrounding environment 6 and factors determining the brightness.

As illustrated in FIG. 1, the environment recognition system 100 includes an optical sensor 3 and a vehicle-mounted apparatus 1. By capturing an image of the surrounding environment 6, the optical sensor 3 forms a captured image of the surrounding environment 6 using brightness information pertaining to the brightness of the surrounding environment 6. The optical sensor 3 corresponds to a “sensor apparatus” according to the present invention. The optical sensor 3 is installed in a vehicle to be capable of capturing conditions to the front in the travel direction, for example.

The vehicle-mounted apparatus 1 includes a trained learning device (a neural network 7, described later) that has been trained to identify the brightness level in the surrounding environment 6 and factors determining the brightness. By inputting brightness information obtained by the optical sensor 3 (the captured images, in the present embodiment) into the learning device, the vehicle-mounted apparatus 1 obtains an environment information set including information of the brightness level of the surrounding environment 6 and factors determining the brightness. The vehicle-mounted apparatus 1 corresponds to an “information processing apparatus” according to the present invention. The vehicle-mounted apparatus 1 also corresponds to a “learning result usage apparatus” that carries out predetermined information processing using the trained learning device. “Environment information set” refers to a format in which a plurality of pieces of environment information are included. “Environment information”, meanwhile, refers to information indicating the brightness level of the surrounding environment or determination factors that determine that brightness. The vehicle-mounted apparatus 1 according to the present embodiment uses the environment information set obtained in this manner to control an air conditioning device 101 and headlights 102 installed in the vehicle. The air conditioning device 101 and the headlights 102 correspond to “modules” according to the present invention.

The learning apparatus 2 according to the present embodiment is a computer that constructs the learning device used by the environment recognition system 100, or in other words, carries out machine learning of a learning device so that the environment information set including the information of the brightness level of the surrounding environment 6 and the factors determining the brightness is outputted in response to the input of the brightness information obtained by the optical sensor 3. Specifically, the learning apparatus 2 obtains the brightness information from the optical sensor 3, and upon the obtained brightness information being inputted, trains the learning device (a neural network 8, described later) to output the environment information set including the information of the brightness level of the surrounding environment 6 and the factors determining the brightness.

Through this, the trained learning device used by the environment recognition system 100 is created. The vehicle-mounted apparatus 1 can obtain the trained learning device created by the learning apparatus 2 over a network 10, for example. The type of the network 10 may be selected as appropriate from among the internet, a wireless communication network, a mobile communication network, a telephone network, a dedicated network, or the like, for example.

Thus as described thus far, according to the present embodiment, both the brightness level and determination factors that determine that brightness can be specified by using the trained learning device that has been trained to identify the brightness level in the surrounding environment 6 and factors determining the brightness. As such, even when the brightness is approximately the same level, the conditions of that situation can be identified, which makes it possible to handle complex conditions in the surrounding environment 6. For example, even when the brightness level is approximately the same, the vehicle-mounted apparatus 1 can change the control of the air conditioning device 101 and the headlights 102 on the basis of the determination factors determining that brightness.

### § 2 Configuration Example

(Hardware Configuration)

<Vehicle-Mounted Apparatus>

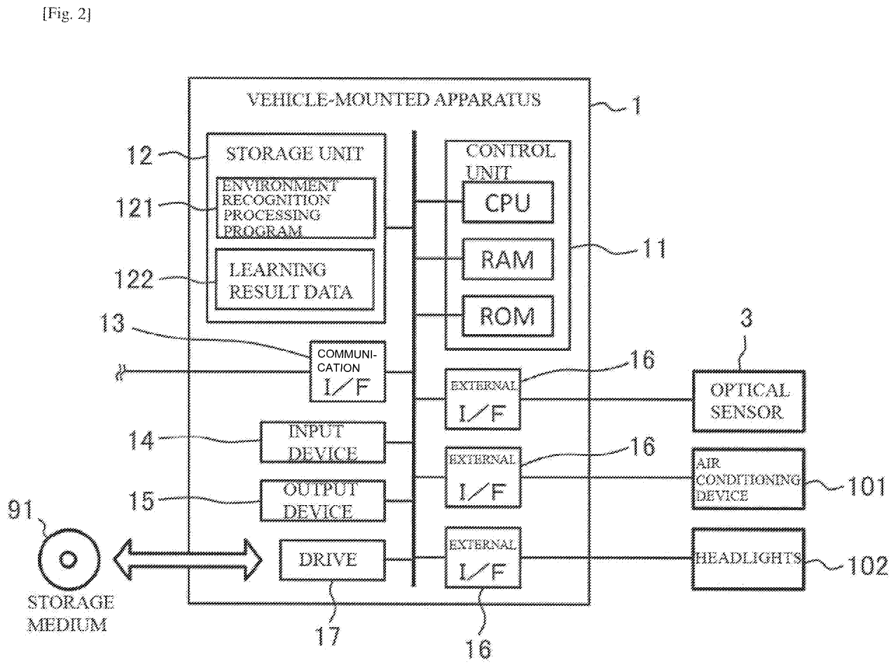

An example of the hardware configuration of the vehicle-mounted apparatus 1 according to the present embodiment will be described next using FIG. 2. FIG. 2 schematically illustrates an example of the hardware configuration of the vehicle-mounted apparatus 1 according to the present embodiment.

As illustrated in FIG. 2, the vehicle-mounted apparatus 1 according to the present embodiment is a computer in which a control unit 11, a storage unit 12, a communication interface 13, an input device 14, an output device 15, an external interface 16, and a drive 17 are electrically connected to each other. The vehicle-mounted apparatus 1 according to the present embodiment corresponds to an “information processing apparatus” according to the present invention. Note that the communication interface and the external interface are denoted as “communication I/F” and “external I/F”, respectively, in FIG. 2.

The control unit 11 includes a central processing unit (CPU), random access memory (RAM), ROM (read-only memory), and so on, and controls the various constituent elements in accordance with information processing. The storage unit 12 is an auxiliary storage device such as a hard disk drive or a solid-state drive, and stores an environment recognition processing program 121 executed by the control unit 11, learning result data 122 indicating information pertaining to the trained learning device, and so on.

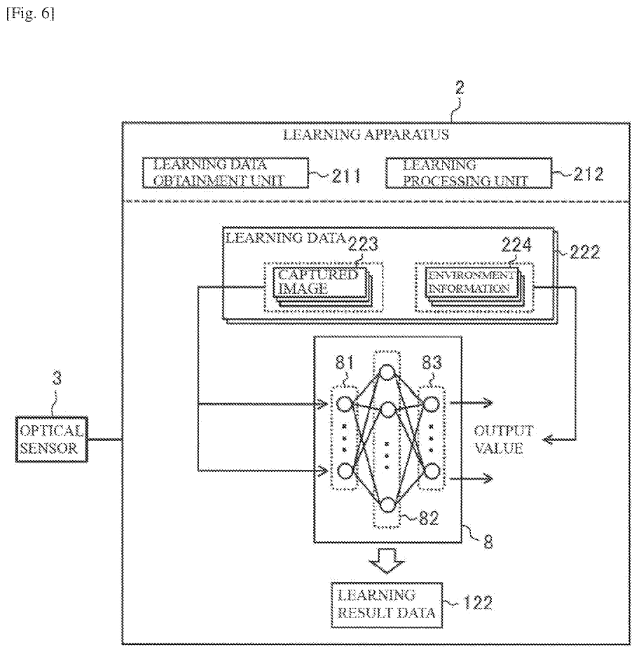

The environment recognition processing program 121 is a program for causing the vehicle-mounted apparatus 1 to carry out a process for analyzing the brightness level in the surrounding environment 6 and factors determining the brightness, which will be described later (FIG. 7). The learning result data 122 is data for configuring the trained learning device. Details will be given later.

The communication interface 13 is a wired local area network (LAN) module, a wireless LAN module, or the like, and is an interface for carrying out wired or wireless communication over a network. The input device 14 is a device for making inputs, such as a button, a touch panel, or a microphone. The output device 15 is a device for output, such as a display or speakers. The external interface 16 is a Universal Serial Bus (USB) port or the like, and is an interface for connecting to an external device such as the optical sensor 3, the air conditioning device 101, and the headlights 102. The communication interface 13 and the external interface 16 may be interfaces having the same connection standard.

The drive 17 is a compact disk (CD) drive, a Digital Versatile Disk (DVD) drive, or the like, and is a device for loading programs stored in a storage medium 91. The type of the drive 17 may be selected as appropriate in accordance with the type of the storage medium 91. The environment recognition processing program 121 and/or the learning result data 122 may be stored in the storage medium 91.

The storage medium 91 is a medium that stores information of programs or the like, recorded by the computer or other devices or machines, through electrical, magnetic, optical, mechanical, or chemical effects so that the program information can read. The vehicle-mounted apparatus 1 may obtain the environment recognition processing program 121 and/or the learning result data 122 from the storage medium 91.

FIG. 2 illustrates an example in which the storage medium 91 is a disk-type storage medium such as a CD or a DVD. However, the type of the storage medium 91 is not limited to a disk, and a type aside from a disk may be used instead. Semiconductor memory such as flash memory can be given as an example of a non-disk type storage medium.

With respect to the specific hardware configuration of the vehicle-mounted apparatus 1, constituent elements can be omitted, replaced, or added as appropriate in accordance with the embodiment. For example, the control unit 11 may include a plurality of processors. The vehicle-mounted apparatus 1 may be constituted by a plurality of information processing apparatuses. Furthermore, rather than an information processing apparatus designed specifically for a service to be provided, such as a programmable logic controller (PLC), the vehicle-mounted apparatus 1 may use a generic desktop personal computer (PC), tablet PC, or the like.

<Optical Sensor>

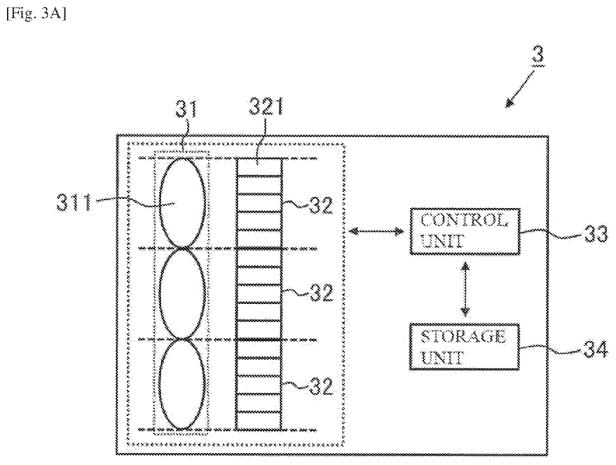

An example of the configuration of the optical sensor 3 according to the present embodiment will be described next using FIGS. 3A and 3B. FIG. 3A schematically illustrates an example of the configuration of the optical sensor 3 according to the present embodiment. FIG. 3B schematically illustrates an example of the relationships between a lens array 31 and image capturing devices 32 in the optical sensor 3 according to the present embodiment.

As illustrated in FIGS. 3A and 3B, the optical sensor 3 according to the present embodiment includes: the lens array 31, having 3×3 lenses 311; 3×3 of the image capturing devices 32 provided so as to correspond to the lenses 311; a control unit 33 that controls the formation of captured images by the image capturing devices 32; and a storage unit 34 that stores programs executed by the control unit 33 and so on.

(Lens Array)

The lens array 31 according to the present embodiment corresponds to an “optical member” according to the present invention, and is a microlens array, for example. However, the dimensions of the lenses 311 in the lens array 31 need not be limited to the micro scale, and may be determined as appropriate in accordance with the embodiment. For example, the sizes of the lenses 311 can be determined in accordance with the image capturing devices 32 that are used.

Each of the lenses 311 corresponds to a “focusing unit” according to the present invention, and is configured as appropriate to focus light from the surrounding environment 6 onto the corresponding image capturing device 32. The optical properties of each of the lenses 311 may be set as appropriate in accordance with the embodiment. “Optical properties” refers to the optical properties of the focusing units, and refers to any properties that alter the state of light between before and after the focusing unit, such as the focus angle, refractive index, band of light allowed to pass (optical density), turbidity, which is a measure of transparency, transmittance, whiteness, which indicates a white level, and tone, indicating coloration. All of the lenses 311 may have identical optical properties, or the optical properties may differ among the lenses 311. The desired optical properties of the lenses 311 can be realized by designing the lenses while adjusting at least one of the size, material, and shape of each lens as appropriate.

The lens array 31 can be manufactured as appropriate from known materials and through a known manufacturing method. For example, the lens array 31 can be manufactured by processing a light-transmissive material such as a resin material or a glass material through a manufacturing method such as injection molding, cutting, welding, or the like. Note that the lens array 31 may be configured so that the focus can be adjusted by appropriately varying the optical axis direction of incident light using a motor (not illustrated) or the like.

(Image Capturing Device)

As illustrated in FIG. 3B, each image capturing device 32 according to the present embodiment is an image sensor having 5×5 light-receiving elements 321. Each light-receiving element 321 is constituted by a complementary MOS (CMOS), a charge-coupled device (CCD), or the like. Accordingly, each image capturing device 32 is configured to be capable of receiving light focused by the corresponding lens 311 in the lens array 31 and form a captured image in which the surrounding environment 6 appears. In the example of FIG. 3B, each image capturing device 32 is configured to be capable of forming a captured image having 5×5 pixels.

The size of each image capturing device 32 can be set as appropriate on the basis of factors such as the size of a subject in the surrounding environment 6 to be captured, the size of a part of the subject to be identified, and the distance to the subject. However, based on the size of the subject and the distance to the subject, it is preferable that an image capturing device having a resolution of one to several hundreds of pixels in the vertical direction and one to several hundreds of pixels in the horizontal direction be used as the image capturing device 32. At this time, the aspect ratio of the image capturing device can be set on the basis of the aspect ratio of a range to be detected.

(Control Unit and Storage Unit)

The control unit 33 is constituted by a microprocessor including a CPU, for example, and the storage unit 34 is constituted by memory such as RAM or ROM. The control unit 33 controls the formation of captured images by the image capturing devices 32 in accordance with a program stored in the storage unit 34. The control unit 33 transfers the captured images formed by the image capturing devices 32 to the storage unit 34 and/or a connected external device (the vehicle-mounted apparatus 1 or the learning apparatus 2, in the present embodiment).

<Learning Apparatus>

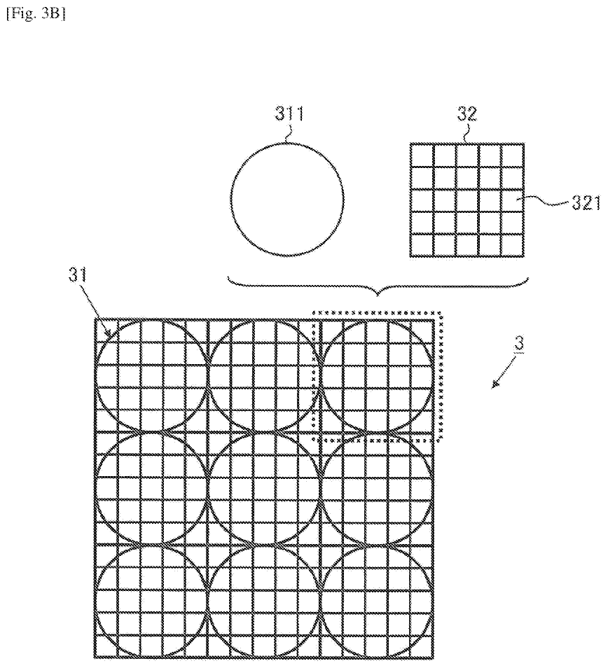

An example of the hardware configuration of the learning apparatus 2 according to the present embodiment will be described next using FIG. 4. FIG. 4 schematically illustrates an example of the hardware configuration of the learning apparatus 2 according to the present embodiment.

As illustrated in FIG. 4, the learning apparatus 2 according to the present embodiment is a computer in which a control unit 21, a storage unit 22, a communication interface 23, an input device 24, an output device 25, an external interface 26, and a drive 27 are electrically connected to each other. As in FIG. 2, the communication interface and the external interface are denoted as “communication I/F” and “external I/F”, respectively, in FIG. 4.

The control unit 21 to the drive 27, and a storage medium 92, are the same as the control unit 11 to the drive 17, and the storage medium 91, of the above-described vehicle-mounted apparatus 1. However, the storage unit 22 of the learning apparatus 2 stores a learning program 221 executed by the control unit 21, learning data 222 used to train the learning device, the learning result data 122 created by executing the learning program 221, and so on.

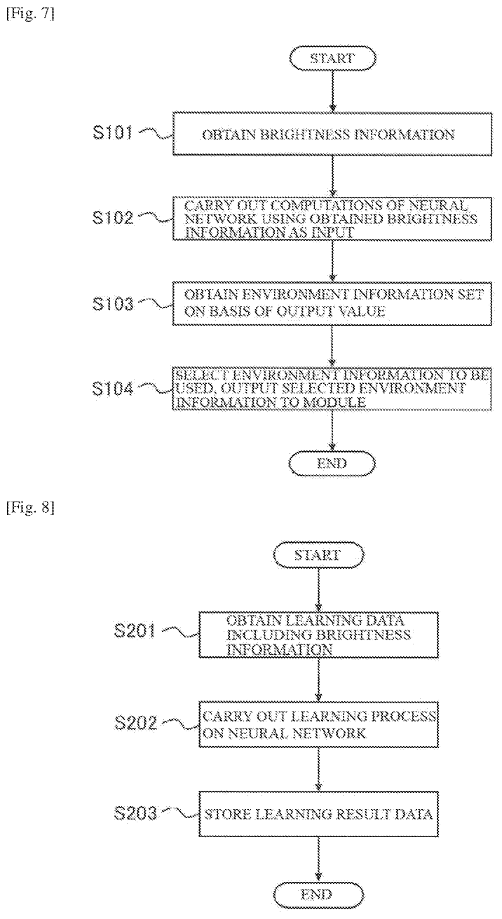

The learning program 221 is a program for causing the learning apparatus 2 to execute a learning process (FIG. 8) for a neural network, described later. The learning data 222 is data for training a learning device to be capable of analyzing the brightness level in the surrounding environment 6 and factors determining the brightness. Details will be given later.

Like the above-described vehicle-mounted apparatus 1, the learning program 221 and/or the learning data 222 may be stored in the storage medium 92. As such, the learning apparatus 2 may obtain the learning program 221 and/or the learning data 222 to be used from the storage medium 92.

Also like the vehicle-mounted apparatus 1, with respect to the specific hardware configuration of the learning apparatus 2, constituent elements can be omitted, replaced, or added as appropriate in accordance with the embodiment. Furthermore, rather than an information processing apparatus designed specifically for a service to be provided, the learning apparatus 2 may use a generic server device, a desktop PC, or the like.

(Functional Configuration)

<Vehicle-Mounted Apparatus>

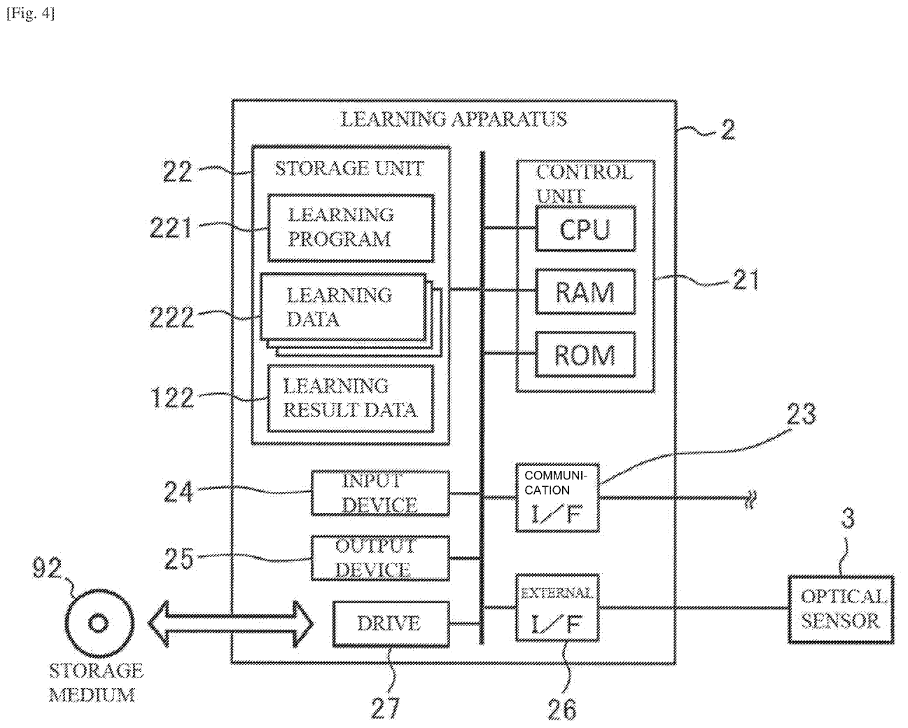

An example of the functional configuration of the vehicle-mounted apparatus 1 according to the present embodiment will be described next using FIG. 5. FIG. 5 schematically illustrates an example of the functional configuration of the vehicle-mounted apparatus 1 according to the present embodiment.

The control unit 11 of the vehicle-mounted apparatus 1 loads the environment recognition processing program 121 stored in the storage unit 12 into the RAM. The control unit 11 then controls the various constituent elements by using the CPU to analyze and execute the environment recognition processing program 121 loaded into the RAM. As a result, as illustrated in FIG. 5, the vehicle-mounted apparatus 1 according to the present embodiment functions as a computer including a brightness information obtainment unit 111, an environment information obtainment unit 112, and an output selection unit 113.

The brightness information obtainment unit 111 obtains each of captured images 123 formed by the image capturing devices 32 from the optical sensor 3 as the brightness information pertaining to the brightness of the surrounding environment 6. The environment information obtainment unit 112 uses the captured images 123 obtained from the image capturing devices 32 as inputs for the learning device that has been trained to identify the brightness level of the surrounding environment 6 and the factors determining the brightness, and obtains output values from the learning device by carrying out the computational processing of the learning device. Then, by specifying the brightness level of the surrounding environment 6 and the factors determining the brightness on the basis of the output values obtained from the learning device, the environment information obtainment unit 112 obtains an environment information set (that is, a plurality of pieces of environment information) including the brightness level of the surrounding environment 6 and factors determining the brightness. The output selection unit 113 selectively outputs a plurality of pieces of the environment information included in the environment information set to modules that use the environment information (the air conditioning device 101 and the headlights 102, in the present embodiment).

The learning device will be described next. As illustrated in FIG. 5, the vehicle-mounted apparatus 1 according to the present embodiment uses the neural network 7 as a learning device trained to be capable of outputting a desired environment information set indicating the brightness level of the surrounding environment 6 and factors determining the brightness. The neural network 7 is a multilayer neural network used in what is known as deep learning, and has an input layer 71, an intermediate layer (hidden layer) 72, and an output layer 73, in order from the input side.

In FIG. 5, the neural network 7 includes one intermediate layer 72, such that the output of the input layer 71 is the input of the intermediate layer 72 and the output of the intermediate layer 72 is the input of the output layer 73. However, the number of intermediate layers 72 need not be limited to one, and the neural network 7 may include two or more intermediate layers 72.

Each of the layers 71 to 73 includes one or more neurons. For example, the number of neurons in the input layer 71 can be set in accordance with the number of pixels in the captured images 123. The number of neurons in the intermediate layer 72 can be set as appropriate in accordance with the embodiment. Additionally, the number of neurons in the output layer 73 can be set in accordance with the number of types of environment information to be analyzed.

Note that the neurons of the output layer 73 correspond to an “output unit” according to the present invention. In the present embodiment, the output layer 73 includes a plurality of neurons so that a plurality of pieces of different types of environment information can be outputted as the environment information set. Each neuron in the output layer 73 is provided for a piece of environment information, and is configured to output an output value indicating the corresponding piece of environment information.

The neurons in adjacent layers are connected to each other as appropriate, and a weight is set for each connection (a connection weight). In the example in FIG. 5, each neuron is connected to all of the neurons in the adjacent layers, but the connections of the neurons need not be limited to this example, and may be set as appropriate in accordance with the embodiment.

A threshold is set for each neuron, and the output of each neuron is basically determined on the basis of whether or not a sum of the products of the neurons and their weights exceeds the threshold. The vehicle-mounted apparatus 1 specifies a plurality of pieces of environment information including the brightness level of the surrounding environment 6 and factors determining the brightness on the basis of the output values obtained from the neurons in the output layer 73 after inputting the captured images 123 into the input layer 71 of the neural network 7.

Information indicating the configuration of the neural network 7 (for example, the number of layers in the neural network 7, the number of neurons in each layer, the connection relationships between neurons, and transfer functions of the neurons), the weights of the connections between the neurons, and the thresholds for the neurons is included in the learning result data 122. The vehicle-mounted apparatus 1 refers to the learning result data 122 and sets a trained neural network 7 using a process for analyzing the brightness level of the surrounding environment 6 and factors determining the brightness.

<Learning Apparatus>

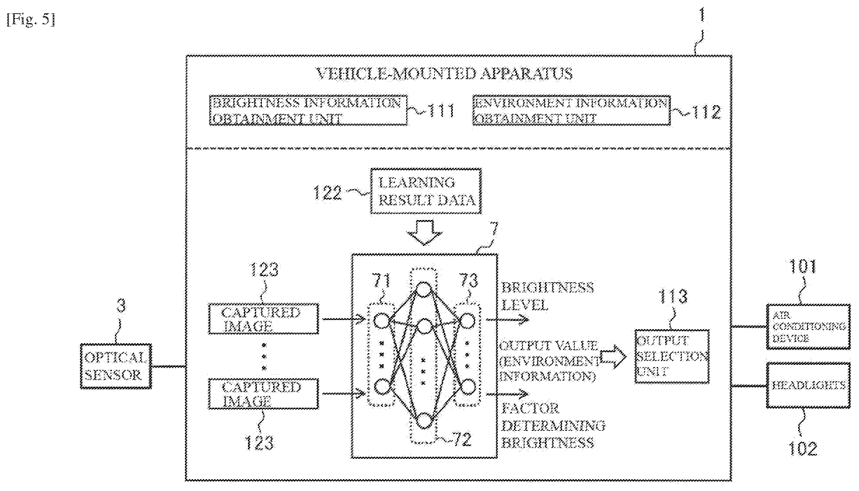

An example of the functional configuration of the learning apparatus 2 according to the present embodiment will be described next using FIG. 6. FIG. 6 schematically illustrates an example of the functional configuration of the learning apparatus 2 according to the present embodiment.

The control unit 21 of the learning apparatus 2 loads the learning program 221 stored in the storage unit 22 into the RAM. The control unit 21 then controls the various constituent elements by using the CPU to analyze and execute the learning program 221 loaded into the RAM. As a result, as illustrated in FIG. 6, the learning apparatus 2 according to the present embodiment functions as a computer including a learning data obtainment unit 211 and a learning processing unit 212.

The learning data obtainment unit 211 obtains, as the learning data 222, a set of a plurality of pieces of environment information 224 (the environment information set), including captured images 223 captured by the image capturing devices 32 of the optical sensor 3 and the information indicating the brightness level of the surrounding environment 6 appearing in the captured images 223 and factors determining the brightness. The learning processing unit 212 uses the learning data 222 to train the learning device to output values corresponding to each piece of the environment information 224 when the obtained captured images 223 are inputted.

As illustrated in FIG. 6, in the present embodiment, the learning device to be trained is the neural network 8. The neural network 8, which is an example of the learning device, includes an input layer 81, an intermediate layer (hidden layer) 82, and an output layer 83, and thus has the same configuration as the neural network 7. The layers 81 to 83 are the same as the layers 71 to 73.

The learning processing unit 212 constructs the neural network 8 through a neural network learning process so that when 3×3 pieces' worth of the captured images 223 are inputted, a plurality of pieces of environment information including information indicating the brightness level of the surrounding environment 6 and factors determining the brightness are outputted from corresponding neurons in the output layer 83. The learning processing unit 212 then stores the information indicating the configuration of the constructed neural network 8, the weights of the connections between the neurons, and the thresholds for the neurons in the storage unit 22 as the learning result data 122.

<Other>

The various functions of the vehicle-mounted apparatus 1 and the learning apparatus 2 will be described in detail later in an operation example. The present embodiment describes an example in which all of the functions of the vehicle-mounted apparatus 1 and the learning apparatus 2 are realized by generic CPUs. However, some or all of the above-described functions may be realized by one or more dedicated processors. With respect to the functional configurations of the vehicle-mounted apparatus 1 and the learning apparatus 2, functions may be omitted, replaced, or added as appropriate in accordance with the embodiment.

### § 3 Operation Example

(Vehicle-Mounted Apparatus)

Next, an example of the operations of the vehicle-mounted apparatus 1 will be described using FIG. 7. FIG. 7 is a flowchart illustrating an example of a processing sequence carried out by the vehicle-mounted apparatus 1. Note that the processing sequence described hereinafter is merely an example, and the processes may be changed as possible. Furthermore, in the processing sequence described hereinafter, steps may be omitted, replaced, or added as appropriate in accordance with the embodiment.

(Startup)

First, a user starts up the vehicle-mounted apparatus 1 and causes the started-up vehicle-mounted apparatus 1 to execute the environment recognition processing program 121. Referring to the learning result data 122, the control unit 11 of the vehicle-mounted apparatus 1 constructs the neural network 7, weights the connections between the neurons, and sets the thresholds for the neurons. The control unit 11 then analyzes the brightness level of the surrounding environment 6 and factors determining the brightness in accordance with the processing sequence described hereinafter. The startup of the vehicle-mounted apparatus 1 may occur in response to the engine of the vehicle being started.

(Step S101)

In step S101, functioning as the brightness information obtainment unit 111, the control unit 11 obtains, as the brightness information, the captured images 123 captured by the image capturing devices 32 from the image capturing devices 32 of the optical sensor 3 connected through the external interface 16. The optical sensor 3 includes 3×3 image capturing devices 32 in the present embodiment, and thus in step S101, the control unit 11 basically obtains 3×3 captured images 123 each time image capturing is carried out.

(Step S102)

Next, in step S102, functioning as the environment information obtainment unit 112, the control unit 11 obtains output values from the neural network 7 by carrying out the computational processing of the neural network 7 using the captured images 123 obtained in step S101 as the input of the neural network 7.

In the present embodiment, the control unit 11 inputs the pixel values of each of the pixels included in the 3×3 captured images 123 obtained in step S101 to corresponding neurons in the input layer 71 of the neural network 7. The correspondence relationships between the inputted pixel values and the neurons in the input layer 71 may be set as appropriate in accordance with the embodiment. Next, the control unit 11 determines whether each of the neurons in the layers 71 to 73 is firing, along the downstream direction. The control unit 11 thus obtains the output values from the plurality of neurons in the output layer 73 of the neural network 7.

(Step S103)

Next, in step S103, functioning as the environment information obtainment unit 112, the control unit 11 specifies the brightness level of the surrounding environment 6 and the factors determining the brightness on the basis of the output values obtained from the neural network 7 in step S102, and thus obtains an environment information set including the brightness level of the surrounding environment 6 and factors determining the brightness.

As described above, the neural network 7 is trained so that when the captured images 123 obtained from the image capturing devices 32 of the optical sensor 3 are inputted, output values corresponding to a desired plurality of pieces of different types of environment information, including information indicating the brightness level and information indicating factors determining the brightness, are outputted. Each of the plurality of neurons in the output layer 73 is provided for a piece of environment information, and outputs an output value indicating the corresponding piece of environment information. The correspondence relationship between the output values of the neural network 7 and the details of each piece of environment information can be set as appropriate, and can be provided as data in table format, for example.

Accordingly, by referring to information indicating the correspondence relationship between the output values of the neural network 7 and the details of each piece of environment information, the control unit 11 can specify the details of each piece of environment information on the basis of the output value obtained from each neuron in the output layer 73 in step S102. As a result, the control unit 11 can obtain a plurality of different types of environment information (the environment information set) including information indicating the brightness level and information indicating factors determining the brightness.

The number of pieces of environment information included in the environment information set may be set as appropriate in accordance with the embodiment, as long as at least one piece each of information indicating the brightness level and information indicating factors determining the brightness are included. For example, the control unit 11 can obtain information indicating a continuous amount using a predetermined physical unit, and/or information indicating a brightness level that represents the brightness in stages, as the environment information indicating the brightness level. The predetermined physical unit may be expressed as at least one of illuminance, sunlight amount, light beams, light intensity, luminescence, light energy, and visibility.

As the environment information indicating factors determining the brightness, the control unit 11 can obtain, for example, information indicating at least one of the presence/absence of light-shielding objects that block light, the type of such light-shielding objects, whether or not the sun is out, the weather, the time, and level of urbanization. “Level of urbanization” refers to the degree of urban development, and is information used to identify whether an area is a metropolitan area, a large city, a medium-to-small city, a rural village, a suburb, an isolated location, or the like, for example.

(Step S104)

Next, in step S104, functioning as the output selection unit 113, the control unit 11 selectively outputs the plurality of pieces of environment information included in the environment information set obtained in step S103 to the modules that use the environment information.

Specifically, in the present embodiment, the air conditioning device 101 and the headlights 102 are installed in the vehicle as the modules that use the environment information. Accordingly, the control unit 11 selects the environment information used by the air conditioning device 101 and the headlights 102 from the plurality of pieces of environment information obtained in step S103. The control unit 11 then outputs the selected environment information to the air conditioning device 101 and the headlights 102.

For example, the plurality of pieces of environment information obtained in step S103 may include information indicating a sunlight amount as the environment information indicating the brightness level, and information indicating the weather as the environment information indicating the factors determining the brightness. In this case, the control unit 11 may select the information indicating the sunlight amount and the information indicating the weather from the plurality of pieces of environment information obtained in step S103, and output the selected information indicating the sunlight amount and information indicating the weather to the air conditioning device 101.

As a result, the control unit 11 can control the air conditioning device 101 on the basis of the sunlight amount and the weather. For example, when it can be determined on the basis of each piece of the environment information that the sunlight amount in the surrounding environment 6 is greater than or equal to a set value and the weather is clear, the control unit 11 may control the air conditioning device 101 to lower the temperature in the vehicle. However, when it can be determined on the basis of each piece of the environment information that the sunlight amount in the surrounding environment 6 is less than a set value and the weather is rainy, the air conditioning device 101 may be controlled to raise the temperature in the vehicle.

Additionally, for example, the plurality of pieces of environment information obtained in step S103 may include information indicating a sunlight amount as the environment information indicating the brightness level, and information indicating the direction of sunlight as the information indicating the factors determining the brightness. In this case, the control unit 11 may select the information indicating the sunlight amount and the information indicating the direction of sunlight from the plurality of pieces of environment information obtained in step S103, and output the selected information indicating the sunlight amount and information indicating the direction of sunlight to the air conditioning device 101.

As a result, the control unit 11 can control the air conditioning device 101 on the basis of the sunlight amount and the direction of sunlight. For example, when carrying out control to vary the air flow and/or temperature on the basis of the sunlight amount, the control unit 11 can further raise/lower the air flow and/or temperature in time periods where sunlight enters the vehicle directly, such as in the morning and in the evening, on the basis of the direction of sunlight. The control unit 11 can furthermore vary the air conditioning control toward the direction in which the sunlight is entering, on the basis of the direction of sunlight. At this time, the control unit 11 can carry out at least one of the following types of control as the air conditioning control toward the direction in which the sunlight is entering: constant control; control to the opposite amount from the air conditioning control on the side where the sunlight is entering; and control at a variation amount lower than the control amount in the air conditioning control on the side where the sunlight is entering.

Additionally, for example, the plurality of pieces of environment information obtained in step S103 may include information indicating illuminance as the environment information indicating the brightness level, and information indicating a type of light-shielding object as the environment information indicating the factors determining the brightness. In this case, the control unit 11 may select the information indicating the illuminance and the information indicating the type of the light-shielding object from the plurality of pieces of environment information obtained in step S103, and output the selected information indicating the illuminance and information indicating the type of light-shielding object to the headlights 102.

As a result, the control unit 11 can control the headlights 102 on the basis of the illuminance and the type of light-shielding object. For example, when it can be determined on the basis of each piece of the environment information that the illuminance in the surrounding environment 6 is less than a set value and that the light-shielding object is a tunnel, the control unit 11 may control the headlights 102 to light up by outputting these pieces of environment information to the headlights 102. However, when it can be determined on the basis of each piece of the environment information that the illuminance in the surrounding environment 6 is greater than or equal to a set value and that the light-shielding object is a building, the control unit 11 may control the headlights 102 not to light up by outputting these pieces of environment information to the headlights 102.

Additionally, rather than allocating the environment information to the modules in a fixed manner as described above, the control unit 11 may allocate the environment information to the modules in a dynamic manner. Specifically, on the basis of the details of each piece of the environment information obtained in step S103, the control unit 11 may select the environment information used by the air conditioning device 101 and the headlights 102 from the plurality of pieces of environment information obtained in step S103.

For example, the plurality of pieces of environment information obtained in step S103 may include two types of information, namely information indicating a sunlight amount and information indicating the light energy, as the environment information indicating the brightness level, and information indicating the weather as the environment information indicating the factors determining the brightness. In this case, the control unit 11 may select the environment information to use with the air conditioning device 101 on the basis of the details of the information indicating the weather.

As a result, the control unit 11 can change the environment information outputted to the air conditioning device 101 on the basis of the weather. For example, when on the basis of the information indicating the weather it can be determined that the weather is clear, the control unit 11 may output information indicating the sunlight amount to the air conditioning device 101. However, when on the basis of the information indicating the weather it can be determined that the weather is rainy, the control unit 11 may output information indicating the light energy to the air conditioning device 101. In this case, the air conditioning device 101 can control the temperature in the vehicle on the basis of the sunlight amount when it is clear, and can control the temperature in the vehicle on the basis of the light energy when it is rainy.

After outputting the environment information selected from the plurality of pieces of environment information to the air conditioning device 101 and the headlights 102, the control unit 11 ends the processing according to the present operation example.

(Learning Apparatus)

Next, an example of the operations of the learning apparatus 2 will be described using FIG. 8. FIG. 8 is a flowchart illustrating an example of a processing sequence carried out by the learning apparatus 2. Note that the processing sequence described hereinafter is merely an example, and the processes may be changed as possible. Furthermore, in the processing sequence described hereinafter, steps may be omitted, replaced, or added as appropriate in accordance with the embodiment.

(Step S201)

In step S201, functioning as the learning data obtainment unit 211, the control unit 21 obtains, as the learning data 222, a set including a plurality of the captured images 223 captured by the optical sensor 3 as well as a plurality of pieces of the environment information 224 including information of the brightness level of the surrounding environment 6 appearing in the captured images 223 and factors determining the brightness.

The learning data 222 is data for training the neural network 8 to be capable of analyzing a desired environment information set including information indicating a brightness level and information indicating factors determining the brightness. The learning data 222 can be created by, for example, using the optical sensor 3 installed in the vehicle to capture images of the surrounding environment 6 under various conditions while the vehicle is traveling, and then associating the captured images that have been obtained with the image capturing conditions.

Specifically, the control unit 21 uses the optical sensor 3 to capture the surrounding environment 6 in which the brightness is at a predetermined level due to predetermined determination factors. Through this, the control unit 21 can obtain, from the image capturing devices 32 of the optical sensor 3, a plurality of captured images 223 showing the surrounding environment 6 in which the predetermined brightness level and predetermined factors determining the brightness to be analyzed are evident. The optical sensor 3 includes 3×3 image capturing devices 32 in the present embodiment, and thus the control unit 21 can obtain 3×3 captured images 223 each time image capturing is carried out.

Next, the control unit 21 accepts, as appropriate, the input of details of the plurality of pieces of the environment information 224 including information indicating the predetermined brightness level evident in the captured images 223 and information indicating the predetermined factors determining the brightness (that is, training data). The control unit 21 can create the learning data 222 by associating the plurality of pieces of the environment information 224 provided by the input with the captured images 223. The learning data 222 may be created manually by an operator or the like using the input device 24, or may be created automatically by a robot or the like.

Here, the learning data 222 may be created using the learning apparatus 2 as described above, or may be created by another information processing apparatus aside from the learning apparatus 2. When the learning apparatus 2 creates the learning data 222, the control unit 21 can obtain the learning data 222 in step S201 by executing a process for creating the learning data 222. However, when another information processing apparatus aside from the learning apparatus 2 creates the learning data 222, the learning apparatus 2 can obtain the learning data 222 created by the other information processing apparatus over a network, from the storage medium 92, or the like. The number of pieces of the learning data 222 obtained in step S201 may be determined as appropriate in accordance with the embodiment so that the neural network 8 can be trained.

(Step S202)

Next, in step S202, functioning as the learning processing unit 212, the control unit 21 uses the learning data 222 obtained in step S201 to train the neural network 8 to output values corresponding to the respective pieces of the environment information 224 when the captured images 223 are inputted.

Specifically, first, the control unit 21 prepares the neural network 8 to be subjected to the learning process. The configuration of the prepared neural network 8, the default values of the weights on the connections between the neurons, and the default values of the thresholds for the neurons may be provided by a template, or may be provided by inputs made by an operator. If retraining is carried out, the control unit 21 may prepare the neural network 8 on the basis of the learning result data 122 subject to the retraining.

Next, the control unit 21 trains the neural network 8 using the plurality of captured images 223 in the learning data 222 obtained in step S201 as input data and the plurality of pieces of the environment information 224 as the training data. Gradient descent, probabilistic gradient descent, or the like may be used in the training of the neural network 8.

For example, the control unit 21 carries out computational processing in the downstream direction of the neural network 8 using the pixel values in each of the captured images 223 as the inputs to the input layer 81. As a result, the control unit 21 obtains output values outputted from the neurons in the output layer 83 of the neural network 8. Next, the control unit 21 calculates error between the output value outputted from each neuron in the output layer 83 and the value indicated by the environment information 224 corresponding to that neuron. Next, through differential reverse propagation, the control unit 21 calculates error in the weights of the connections between the neurons and in the thresholds for the neurons using the calculated error in the output values. Then, on the basis of the calculated errors, the control unit 21 updates the values of the weights of the connections between the neurons and the thresholds for the neurons.

The control unit 21 trains the neural network 8 by repeating this series of processes for each piece of the learning data 222 until the output values outputted from the neurons in the output layer 83 match the values indicated by the corresponding environment information 224. As a result, the neural network 8 that outputs output values corresponding to the pieces of the environment information 224 when the captured images 223 are inputted can be constructed.

(Step S203)

Next, in step S203, functioning as the learning processing unit 212, the control unit 21 stores the information indicating the configuration of the constructed neural network 8, the weights of the connections between the neurons, and the thresholds for the neurons in the storage unit 22 as the learning result data 122. Through this, the control unit 21 ends the process of training the neural network 8 according to this operation example.

Note that the control unit 21 may transfer the created learning result data 122 to the vehicle-mounted apparatus 1 after the process of step S203 is complete. The control unit 21 may also periodically update the learning result data 122 by periodically executing the learning process of steps S201 to S203. The control unit 21 may periodically update the learning result data 122 held in the vehicle-mounted apparatus 1 by transferring the created learning result data 122 to the vehicle-mounted apparatus 1 each time the learning process is executed.

(Effects)

As described thus far, according to the present embodiment, the trained neural network 7, which has been trained to identify the brightness level in the surrounding environment 6 and factors determining the brightness, is used in step S102. In the training part, too, the neural network 8 is trained to be capable of identifying the brightness level of the surrounding environment 6 and factors determining the brightness. Thus in step S103, information indicating determination factors that determine the brightness can be obtained as well as the information indicating the brightness level.

As such, according to the present embodiment, even when the brightness is approximately the same level, the conditions of that situation can be identified on the basis of the information indicating factors determining the brightness, which makes it possible to handle complex conditions in the surrounding environment 6. For example, in step S104, even if the brightness level is the same, the vehicle-mounted apparatus 1 can cause the headlights 102 to light up when a light-shielding object is a tunnel and cause the headlights 102 to not light up when the light-shielding object is a building.

Additionally, according to the present embodiment, in step S104, the control unit 11 may select the environment information used by the modules on the basis of the details of the environment information. This makes complex control of the modules possible. For example, the air conditioning device 101 can be controlled on the basis of the sunlight amount when it is clear, and the air conditioning device 101 can be controlled on the basis of the light energy when it is raining, as described above.

### § 4 Variations

Although an embodiment of the present invention has been described in detail thus far, the foregoing descriptions are intended to be nothing more than an example of the present invention in all senses. It goes without saying that many improvements and changes can be made without departing from the scope of the present invention. For example, variations such as those described below are also possible. In the following, constituent elements that are the same as those in the above-described embodiment will be given the same reference signs, and points that are the same as in the above-described embodiment will not be described. The following variations can also be combined as appropriate.

<4.1>

In the embodiment described above, typical feed-forward neural networks having multilayer structures are used as the neural networks (7, 8), as illustrated in FIGS. 5 and 6. However, the types of the neural networks (7, 8) need not be limited to this example, and may be selected as appropriate in accordance with the embodiment. For example, the neural networks (7, 8) may be convolutional neural networks using the input layer and the intermediate layer as a convolutional layer and a pooling layer. Alternatively, the neural networks (7, 8) may be recursive neural networks having recursive connections from the output side to the input side, such as from the intermediate layer to the input layer. The number of layers in the neural networks (7, 8), the number of neurons in each layer, the connection relationships between neurons, and the transfer functions of the neurons may be set as appropriate in accordance with the embodiment.

<4.2>

In the embodiment described above, the vehicle-mounted apparatus 1 that analyzes the brightness level of the surrounding environment 6 and the factors determining the brightness, and the learning apparatus 2 that trains the learning device (neural network), are constituted by separate computers. However, the configurations of the vehicle-mounted apparatus 1 and the learning apparatus 2 need not be limited to this example, and a system having the functions of both the vehicle-mounted apparatus 1 and the learning apparatus 2 may be realized by one or more computers. For example, the environment recognition system 100 itself may have a function for generating a learning device by the learning apparatus 2. In this case, the vehicle-mounted apparatus 1 and the learning apparatus 2 are connected through internal communication (an internal bus) to be capable of exchanging information.

<4.3>

In the embodiment described above, the vehicle-mounted apparatus 1 outputs the pieces of the environment information to the air conditioning device 101 and the headlights 102. However, the output destination of the environment information need not be limited to modules such as the air conditioning device 101 and the headlights 102, and may be selected as appropriate in accordance with the embodiment. For example, the vehicle-mounted apparatus 1 may output the pieces of the environment information to a user through the output device 15. The modules that can serve as output destinations of the environment information may include units of hardware or software that change some kind of physical state, or combinations of such hardware or software units. The modules may include a general control device that carries out general control of individual units of hardware or software or a plurality of combinations thereof, such as an Engine Control Unit (ECU) provided in a vehicle.

In the embodiment described above, the pieces of the environment information are outputted to the air conditioning device 101 and the headlights 102 by the output selection unit 113. The output selection unit 113 may output the environment information to the modules directly or indirectly. In other words, the output from the output selection unit 113 may be outputted directly to the modules by having the information processing apparatus and the modules connected to each other directly, or the output from the output selection unit 113 may be outputted indirectly to the modules by having the information processing apparatus and the modules connected via a predetermined relay device. However, the method of outputting the pieces of environment information to the modules need not be limited to this example, and the output selection unit 113 may be omitted.

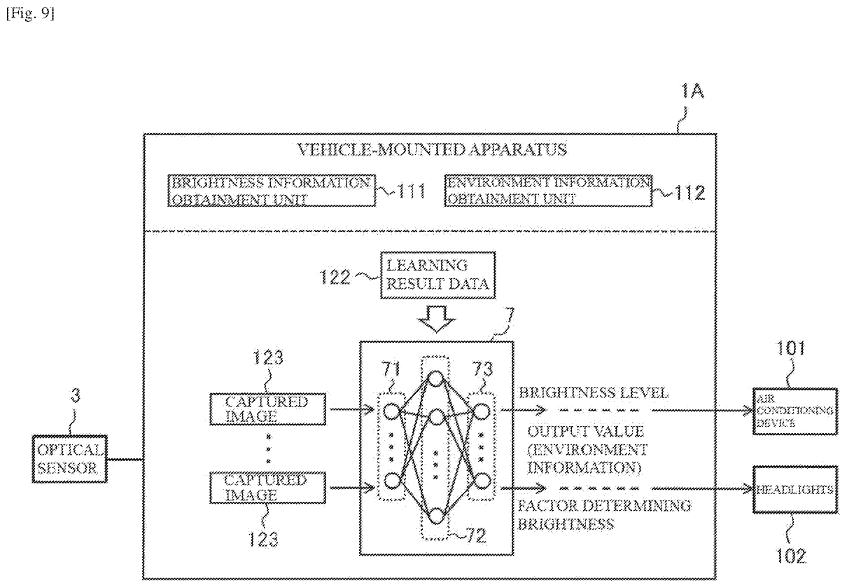

FIG. 9 schematically illustrates a vehicle-mounted apparatus 1A according to the present variation. In the example of FIG. 9, the plurality of neurons in the output layer 73 of the neural network 7 are associated with the two modules that use the environment information (the air conditioning device 101 and the headlights 102). Each neuron outputs a piece of the environment information (an output value) to the corresponding module. Aside from this, the vehicle-mounted apparatus 1A has the same configuration as the vehicle-mounted apparatus 1 described above. This makes it possible to control the modules on the basis of the environment information more quickly, as the processing of the output selection unit 113 can be omitted.

In the present variation, the number of modules that use the environment information need not be limited to two, and may be three or more. Furthermore, the number of neurons in the output layer 73 may be set as appropriate in accordance with the number of modules using the environment information and the number of output values used by the modules.

<4.4>

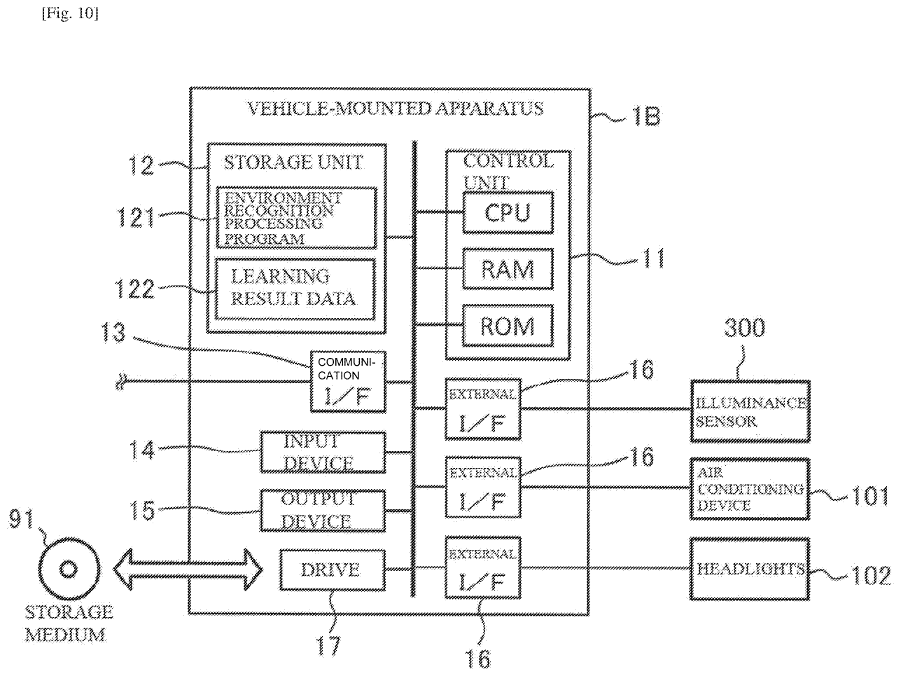

In the embodiment described above, the optical sensor 3 is used as a sensor apparatus that detects the brightness information pertaining to the brightness of the surrounding environment 6. However, the sensor apparatus that can be used in the present invention need not be limited to an optical sensor, and may be selected as appropriate in accordance with the embodiment. Additionally, the brightness information may be any information indicating brightness, and in addition to the captured images of the above-described embodiment, may be a brightness measurement value or the like. For example, an infrared light sensor, a typical camera, or the like can be used as the sensor apparatus. An illuminance sensor can also be used as the sensor apparatus, as illustrated in the example of FIG. 10.

FIG. 10 schematically illustrates a vehicle-mounted apparatus 1B according to the present variation. The vehicle-mounted apparatus 1B is connected to an illuminance sensor 300 via the external interface 16. Aside from this, the vehicle-mounted apparatus 1B has the same configuration as the vehicle-mounted apparatus 1 described above. The illuminance sensor 300 is constituted by a phototransistor or the like, to be capable of measuring illuminance. In the present variation, the illuminance sensor 300 corresponds to the “sensor apparatus” according to the present invention, and the vehicle-mounted apparatus 1B uses illuminance measurement values from the illuminance sensor 300 as the brightness information to input to the neural network 7.

The number of illuminance sensors 300 connected to the vehicle-mounted apparatus 1B need not be limited to one, and may be two or more. By connecting a plurality of illuminance sensors 300 arranged to be oriented in different directions, the vehicle-mounted apparatus 1B can detect brightness information from different directions.

In the embodiment described above, the optical sensor 3 includes 3×3 image capturing devices 32, and thus brightness information (captured images) can be detected in each of three different directions. In the present variation, too, three or more illuminance sensors 300 may be arranged to be oriented in different directions, so that brightness information can be detected from three or more different directions. Detecting the brightness information from three or more different directions makes it possible to increase the diversity of the input data inputted to the neural network 7, which in turn makes it possible to increase the accuracy of analyzing the brightness level of the surrounding environment 6 and the factors determining the brightness.

<4.5>

In the embodiment described above, the learning device is constituted by a neural network. However, as long as the brightness information can be used as inputs, the type of the learning device need not be limited to a neural network, and may be selected as appropriate in accordance with the embodiment. Aside from the neural networks described above, a learning device constituted by a support vector machine, a self-organizing map, or a learning device that learns through reinforcement learning can be given as an example of a learning device that can input the plurality of captured images 123.

<4.6>

In the embodiment described above, the vehicle-mounted apparatus 1 is described as an example of the information processing apparatus of the environment recognition system. In other words, the example is one in which the present invention is applied in a vehicle-mounted system installed in a vehicle. However, the type of the information processing apparatus need not be limited to a vehicle-mounted apparatus, and may be selected as appropriate in accordance with the embodiment. For example, the present invention may be applied in a control device that controls modules installed in a structure such as a building.

For example, in the embodiment described above, the air conditioning device 101 and the headlights 102 are given as example of the modules that use the environment information. However, the modules that use the environment information need not be limited to such an example, as long as the modules are devices that can use the environment information, and may include the backlight in the display of a car navigation device, for example. Additionally, the modules that use the environment information need not be limited to devices installed in a vehicle such as an automobile, and may instead be an air conditioning device, a window blind device, lighting, or the like.

<4.7>

In the embodiment described above, the lens array 31 includes 3×3 lenses 311, and accordingly, the optical sensor 3 includes 3×3 image capturing devices 32. However, the number of lenses 311 in the lens array 31 and the number of image capturing devices 32 need not be limited to this example, and may be set as appropriate in accordance with the embodiment. Additionally, the lenses 311 and the image capturing devices 32 do not need to correspond one-to-one.

Furthermore, in the embodiment described above, the configuration is such that each image capturing device 32 includes 5×5 light-receiving elements 321, and thus a captured image having 5×5 pixels can be formed. However, the number of pixels in the captured image formed by each image capturing device 32, or in other words, the number of light-receiving elements 321 in the image capturing device 32, need not be limited to this example, and may be selected as appropriate in accordance with the embodiment. Additionally, each image capturing device 32 may have a different number of pixels.

<4.8>

In the embodiment described above, a lens array is used as an example of an optical member having a plurality of focusing units that each focus light from a subject. However, the type of the optical member need not be limited to a lens array, and may be selected as appropriate in accordance with the embodiment. Aside from a lens array, the optical member may include at least one of a diffraction grating, a diffusion lens, and a hologram lens. Additionally, an optical member that transmits light to the image capturing devices in an irregular manner, such as a frosted glass-type plate, may be used instead of a lens-shaped member. If a diffraction grating, a diffusion lens, or a hologram lens is used, a part that allows light to be incident on a single image capturing device serves as a focusing unit. In other words, although a diffraction grating, a diffusion lens, and a hologram lens are typically formed as flat plates, a plurality of focusing units are present in the flat plate-shaped optical member, corresponding to the image capturing devices that receive the light through the optical member. Note that the optical properties, such as the focus angle, refractive index, and band of light allowed to pass, need not be the same for each focusing unit provided corresponding to the image capturing devices.

<4.9>

In the embodiment described above, the optical properties of each of the lenses 311 may be set as appropriate in accordance with the embodiment. Accordingly, of the plurality (3×3, in the embodiment) of lenses 311, at least one of the lenses 311 may be configured to have different optical properties from the other lenses 311. The diversity of the captured images obtained can be increased.

Furthermore, at least some of the plurality of lenses 311 may have irregular optical properties. For example, the optical properties of the lenses 311 may be set at random. The desired optical properties of the lenses 311 can be realized by designing the lenses 311 while adjusting at least one of the size, material, and shape of each lens 311 as appropriate.

As a result, the diversity of the captured images obtained can be increased, and thus the accuracy of analyzing the brightness level of the surrounding environment 6 and the factors determining the brightness can be improved. Note that at least some of the plurality of lenses 311 having “irregular optical properties” refers to a state in which the optical properties differ between adjacent lenses 311.

However, the range of irregularity need not be limited to part of the lens array 31, and may instead be the entire lens array 31. For example, the optical properties may be set to be random throughout the entire lens array 31 so that the optical properties for all of the lenses 311 are irregular.

Additionally, as in the variation described above, the optical member in which at least some of the focusing units have irregular optical properties can be configured as a member aside from a lens array. For example, providing irregular non-planarities or grooves in the surface of a frosted glass-type optical member makes it possible to set irregular optical properties in the range where the non-planarities or grooves are provided.

<4.10>

The vehicle-mounted apparatus 1 described above may be configured to hold a plurality of pieces of the learning result data 122 and be capable of switching the neural network 7 used in response to user instructions. In this case, the vehicle-mounted apparatus 1 may obtain each piece of the learning result data 122 from the learning apparatus 2 over the network 10, or from the storage medium 91 via the drive 17, in response to the input device 14 being operated by a user. Alternatively, the vehicle-mounted apparatus 1 may obtain each piece of the learning result data 122 by accepting transmissions from the learning apparatus 2. Furthermore, each piece of the learning result data 122 may be stored in another information processing apparatus (storage device) such as network-attached storage (NAS), and the vehicle-mounted apparatus 1 may obtain each piece of the learning result data 122 by accessing that other information processing apparatus.

1. An environment recognition system comprising:
a sensor configured to detect brightness information pertaining to a brightness of a surrounding environment; and
an information processing apparatus that obtains, by inputting the brightness information obtained by the sensor into a learning device that has been trained for identifying a brightness level of the surrounding environment and a factor determining the brightness, an environment information set comprising information of the brightness level of the surrounding environment and the factor determining the brightness.

2. The environment recognition system according to claim 1, wherein
the environment information set comprises a plurality of pieces of environment information of different types; and
the learning device comprises a plurality of output units, each output unit provided for one of the pieces of environment information, and each output unit outputting a corresponding one of the pieces of environment information.

3. The environment recognition system according to claim 2, wherein
the information processing apparatus comprises an output selection unit configured to selectively output a plurality of pieces of the environment information comprised in the environment information set to a module that uses the environment information; and
the output selection unit selects environment information to use from among the environment information outputted from the output units, and outputs the selected environment information to the module.

4. The environment recognition system according to claim 3, wherein the output selection unit selects the environment information to use from among the environment information outputted from the output units on the basis of details of the environment information outputted from the output units, and outputs the selected environment information to the module.

5. The environment recognition system according to claim 2, wherein the plurality of output units are associated with a plurality of modules that use the environment information, and each output unit outputs a piece of the environment information to the module corresponding to that output unit.

6. The environment recognition system according to claim 1, wherein the sensor is configured to detect the brightness information from each of three or more different directions.

7. The environment recognition system according to claim 1, wherein the sensor comprises an optical sensor, the optical sensor comprising an optical member comprising a plurality of focusing units that each focuses light from the surrounding environment, and a plurality of image capturing devices, each image capturing device provided corresponding to one of the focusing units and configured to receive the light focused by the focusing unit and form a captured image in which the surrounding environment appears as the brightness information.

8. The environment recognition system according to claim 7, wherein at least one focusing unit among the plurality of focusing units has different optical properties from the other focusing units.

9. The environment recognition system according to claim 7, wherein at least some of the plurality of focusing units have irregular optical properties.

10. The environment recognition system according to claim 7, wherein the optical member comprises at least one of a lens array, a diffraction grating, a diffusion lens, and a hologram lens.

11. The environment recognition system according to claim 1, wherein the sensor comprises one or more illuminance sensors.

12. The environment recognition system according to claim 1, wherein the learning device comprises a neural network, a support vector machine, a self-organizing map, or a learning device that learns through reinforcement learning.

13. The environment recognition system according to claim 1, wherein the brightness level is expressed as a continuous amount using a predetermined physical unit, and/or as a brightness level that represents the brightness in stages.

14. The environment recognition system according to claim 13, wherein the predetermined physical unit is expressed as at least one of illuminance, sunlight amount, light beams, light intensity, luminescence, light energy, and visibility.

15. The environment recognition system according to claim 1, wherein the factor determining the brightness is expressed by at least one of a presence/absence of a light-shielding object that blocks light, a type of the light-shielding object, whether or not the sun is out, the weather, the time, and a level of urbanization.

16. A learning apparatus comprising a processor configured with a program to perform operations comprising:
operation as an information obtainment unit configured to obtain brightness information pertaining to a brightness of a surrounding environment from a sensor configured to detect the brightness information; and
operation as a learning processing unit configured to train a learning device to output an environment information set comprising information of a brightness level of the surrounding environment and a factor determining the brightness upon the obtained brightness information being inputted.

17. The environment recognition system according to claim 2, wherein the sensor is configured to detect the brightness information from each of three or more different directions.

18. The environment recognition system according to claim 2, wherein the sensor comprises an optical sensor, the optical sensor comprising an optical member comprising a plurality of focusing units that each focuses light from the surrounding environment, and a plurality of image capturing devices, each image capturing device provided corresponding to one of the focusing units and configured to receive the light focused by the focusing unit and form a captured image in which the surrounding environment appears as the brightness information.

19. The environment recognition system according to claim 18, wherein at least one focusing unit among the plurality of focusing units has different optical properties from the other focusing units.

20. The environment recognition system according to claim 18, wherein at least some of the plurality of focusing units have irregular optical properties.
